(19) United States
(12) Patent Application Publication
(10) Pub. No.: US 2004/0036805 A1
(43) Pub. Date: Feb. 26, 2004

(54) Device to adapt any incoming TV signal aspect ratio to full screen TV aspect ratio 4:3

(76) Inventors: Adam B. Nevins, Johnstown, PA (US); Keith A. Varner, St. Michael, PA (US)

Correspondence Address: LITTMAN LAW OFFICES, LTD., P.O. BOX 15035 CRYSTAL CITY STATION, ARLINGTON, VA, 22215, US

(21) Appl. No.: 10/224,453

(22) Filed: Aug. 21, 2002

(51) Int. Cl. H04N 11/20

(52) U.S. Cl. 348/556; 348/445

(57) ABSTRACT

A device to adapt any incoming TV signal aspect ratio to a full screen TV with an aspect ratio of 4:3. The device includes a housing with signal input terminals and signal output terminals. The signal input terminals may include cable/satellite input terminals, S-video input terminals, audio input terminals, standard video input terminals, and component input terminals. The signal output terminals may include a cable output terminal, an S-video output terminal, audio output terminals, a standard video output terminal, and component video output terminals. The device may also include an electrical cord with a plug to connect the device to an external power source. The device may also include hand elements for enabling a user to readily carry the device. Contained within the device is electrical circuitry including a video signal detector, a demodulator, a transport demultiplexer, a video decoder, an audio decoder, and an aspect ratio converter.

### BACKGROUND OF THE INVENTION

1. Field of the Invention

The present invention generally relates to a device that adapts television (TV) signal aspect ratios, and more particularly to a device that adapts any incoming TV signal aspect ratio to a full screen TV having a predetermined aspect ratio.

2. Description of the Related Art

The aspect ratio is defined as the ratio of frame width to frame height in television. Currently used aspect ratios include standard television (4:3), some European cinema films (15:9), widescreen television (16:9), some American cinema films (16.65:9), and Cinemascope/Panavision films (21:9). In the United States television pictures are broadcast according to the National Television System Committee (NTSC) composite standards. The NTSC broadcast standard has been an aspect ratio of 4:3 for many years. Presently, most digital video disk (DVD) releases are in widescreen format, e.g., an aspect ratio of 16:9. Some broadcast studios are already broadcasting some of their signals in widescreen format. As of 2006, all broadcasting will be in widescreen format. While widescreen televisions are currently available, most consumers have televisions with an aspect ratio of 4:3. Televisions with an aspect ratio of 4:3 are currently only able to display a widescreen image in a letterbox format, e.g. with black bars on the top and bottom of the screen. Therefore, a need exists for a device which can adapt any incoming TV signal to a full screen TV with an aspect ratio of 4:3.

The related art is represented by the following references of interest.

U.S. Pat. No. 4,894,789, issued on Jan. 16, 1990 to Keen Y. Yee, describes a television (TV) data capture device which allows the capture and display of digital data sent with video signals. Yee does not suggest a device to adapt any incoming TV signal aspect ratio to a full screen TV with an aspect ratio of 4:3.

U.S. Pat. No. 4,943,852, issued on Jul. 24, 1990 to Philip A. Femano et al., describes a stereoscopic converter assembly for use in a closed circuit 2-D TV system. Femano et al. does not suggest a device to adapt any incoming TV signal aspect ratio to a full screen TV with an aspect ratio of 4:3.

U.S. Pat. No. 5,442,403, issued on Aug. 15, 1995 to Yoshio Yasumoto et al., describes a wide-screen TV signal transmitting apparatus which is compatible with a conventional TV standard. Yasumoto et al. does not suggest a device to adapt any incoming TV signal aspect ratio to a full screen TV with an aspect ratio of 4:3.

U.S. Pat. No. 5,497,198, issued on Mar. 5, 1996 to Kyung S. Kim, describes a high definition TV signal conversion circuit using a side cut mode or a letter box mode. Kim does not suggest a device to adapt any incoming TV signal aspect ratio to a full screen TV with an aspect ratio of 4:3.

U.S. Pat. No. 5,610,663, issued on Mar. 11, 1997 to Liu P. Nan et al., describes a multi-frequency displaying device for displaying both TV and personal computer video signals. Nan et al. does not suggest a device to adapt any incoming TV signal aspect ratio to a full screen TV with an aspect ratio of 4:3.

U.S. Pat. No. 5,612,749, issued on Mar. 18, 1997 to Emil G. Bacher et al., describes an apparatus and method for receiving messages from a central transmitter with a TV receiver. Bacher et al. does not suggest a device to adapt any incoming TV signal aspect ratio to a full screen TV with an aspect ratio of 4:3.

U.S. Pat. No. 5,912,711, issued on Jun. 15, 1999 to Lie-Der Lin et al., describes an apparatus for converting and scaling a non-interlaced Video Graphics Adapter signal to an interlaced TV signal suitable to be displayed on a TV video screen. Lin et al. does not suggest a device to adapt any incoming TV signal aspect ratio to a full screen TV with an aspect ratio of 4:3.

U.S. Pat. No. 5,940,072, issued on Aug. 17, 1999 to Musa Jahanghir et al., describes a graphics data decompression arrangement in a TV set top box that includes a system read-only memory for storing graphics data broken down into tiles, each of which is identified by a unique index number. Jahanghir et al. does not suggest a device to adapt any incoming TV signal aspect ratio to a full screen TV with an aspect ratio of 4:3.

U.S. Pat. No. 6,137,469, issued on Oct. 24, 2000 to Ming Chi Wu et al., describes a computer-TV video converting apparatus which transfers any determined partial area of a computer display into a zoomed image displayed onto a large scale TV screen used for a briefing or a seminar in addition to a preformed partial area converting function. Wu et al. does not suggest a device to adapt any incoming TV signal aspect ratio to a full screen TV with an aspect ratio of 4:3.

U.S. Pat. No. 6,219,101 B1, issued on Apr. 17, 2001 to Mehdi H. Sani et al., describes a method and apparatus for converting video signals from a format having sequential scanning to an interlaced scanning format as used in composite video. Sani et al. does not suggest a device to adapt any incoming TV signal aspect ratio to a full screen TV with an aspect ratio of 4:3.

German Patent document DE 4002811 A1, published on Aug. 2, 1990, describes a distribution box with attenuators for a community antenna TV. German '811 does not suggest a device to adapt any incoming TV signal aspect ratio to a full screen TV with an aspect ratio of 4:3.

International Patent document WO 95/35625, published on Dec. 28, 1995, describes a digital video signal processing system. International '625 does not suggest a device to adapt any incoming TV signal aspect ratio to a full screen TV with an aspect ratio of 4:3.

International Patent document WO 00/57640, published on Sep. 28, 2000, describes a cable converter box capable of receiving a cable signal that includes both NTSC and digital TV formatted signals. International '640 does not suggest a device to adapt any incoming TV signal aspect ratio to a full screen TV with an aspect ratio of 4:3.

None of the above inventions and patents, taken either singularly or in combination, is seen to describe the instant invention as claimed.

### SUMMARY OF THE INVENTION

The present invention is a device and method to adapt any incoming TV signal aspect ratio to a full screen TV with an aspect ratio of 4:3. The device includes a housing with signal input terminals and signal output terminals. The signal input terminals may include cable/satellite input terminals, S-video input terminals, audio input terminals, standard video input terminals, and component input terminals. The signal output terminals may include a cable output terminal, an S-video output terminal, audio output terminals, a standard video output terminal, and component video output terminals. The particular number of input terminals and output terminals may vary according to the desires of the user. The device may also include an electrical cord with a plug to connect the device to an external power source. The device may also include hand elements for enabling a user to readily carry the device.

Contained within the device is electrical circuitry including a video signal detector, a demodulator, a transport demultiplexer, a video decoder, an audio decoder, and an aspect ratio converter. These elements may be configured in the form of integrated electronic circuitry and are electrically interconnected with each other.

An incoming video signal having any TV signal aspect ratio is received through one of the input signal terminals. This incoming TV signal may be from a DVD disk, a video cassette, a signal from a cable or satellite, or the like. The incoming TV signal includes a vertical blanking section and a video data section. The vertical blanking section is used by televisions to turn an electron beam off while an electron beam controller resets the position of the electron beam to the upper left corner of the television screen. The vertical blanking section also includes an identification signal which includes the aspect ratio information of the video signal. The video data section includes data which makes up the video picture.

Once the incoming video signal is detected by the video signal detector, the video signal detector transfers the video signal to the video demodulator. The video demodulator demodulates the video signal and transfers the demodulated video signal to a transport demultiplexer. The transport demultiplexer separates the video signal into a video portion signal and an audio portion signal. The video portion signal is then transferred to the video decoder which decodes, analyzes, and determines the aspect ratio of the video signal. The decoded video portion signal is then transferred to the aspect ratio converter.

The aspect ratio converter converts an aspect parameter or an aspect factor of the decoded video portion signal and outputs a modified video portion signal having an aspect ratio of 4:3 with no black bars on the top and bottom of the modified video portion signal. For example, if the incoming decoded video portion signal has an aspect ratio of 16:9, the aspect ratio converter may modify the decoded video portion signal by zooming into the center of the 16:9 image and-cutting out the center of the 16:9 image. The cut out portion of the 16:9 image, e.g., the modified video portion signal, is then transferred to a signal output terminal. However, if the incoming decoded video portion has an aspect ratio of 4:3, the aspect ratio converter will do nothing and will transfer the decoded video portion signal as the modified video portion signal to a signal output terminal.

Accordingly, it is a principal aspect of the invention to provide a device to adapt any incoming TV signal aspect ratio to a full screen TV with an aspect ratio of 4:3.

It is another aspect of the invention to provide a device to adapt any incoming TV signal aspect ratio to a full screen TV with an aspect ratio of 4:3 that includes a video signal detector, a demodulator, a transport demultiplexer, a video decoder, an audio decoder, and an aspect ratio converter, wherein the device is configured to adapt any incoming TV signal aspect ratio to a full screen TV with an aspect ratio of 4:3.

It is a further aspect of the invention to provide a device to adapt any incoming TV signal aspect ratio to a full screen TV with an aspect ratio of 4:3 that includes an electrical cord with a plug configured to connect said device to an external power source

Still another aspect of the invention is to provide a device to adapt any incoming TV signal aspect ratio to a full screen TV with an aspect ratio of 4:3 that includes a housing with signal input terminals and signal output terminals.

Yet another aspect of the invention is to provide a device to adapt any incoming TV signal aspect ratio to a full screen TV with an aspect ratio of 4:3 that has signal input terminals including at least one cable/satellite input terminal, at least one S-video input terminal, at least one set of left and right audio input terminals, at least one standard video input terminal, and at least one component input terminal.

Still another aspect of the invention is to provide a device to adapt any incoming TV signal aspect ratio to a full screen TV with an aspect ratio of 4:3 that has signal output terminals including at least one cable output terminal, at least one S-video output terminal, at least one set of left and right audio output terminals, at least one standard video output terminal, and at least one component video output terminal.

Yet another aspect of the invention is to provide a device to adapt any incoming TV signal aspect ratio to a full screen TV with an aspect ratio of 4:3 that has hand elements configured to enable a user to carry the device.

Still another aspect of the invention is to provide a method of adapting any incoming TV signal aspect ratio to a full screen TV with an aspect ratio of 4:3, the method including detecting an incoming video signal, demodulating the incoming video signal, separating the video signal into a video portion signal and an audio portion signal, decoding, analyzing, and determining an aspect ratio of the video signal, if the aspect ratio of the video portion signal is not 4:3 converting the video portion signal into a modified video portion signal having a full screen aspect ratio of 4:3, and if the aspect ration of the video portion signal is 4:3 doing nothing to the video portion signal and transferring the video portion signal as a modified video portion signal

It is an aspect of the invention to provide improved elements and arrangements thereof in a device to adapt any incoming TV signal aspect ratio to a full screen TV with an aspect ratio of 4:3 for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a front view of a device according to the invention that adapts any incoming TV signal aspect ratio to a full screen TV with an aspect ratio of 4:3.

FIG. 2 is a block diagram of a device according to the invention that adapts any incoming TV signal aspect ratio to a full screen TV with an aspect ratio of 4:3.

Similar reference characters denote corresponding features consistently throughout the attached drawings.

### DETAILED DESCRIPTION OF THE PREFERRED EMBODIMENT

The present invention is a method and device to adapt any incoming TV signal aspect ratio to a full screen TV with an aspect ratio of 4:3. The invention disclosed herein is, of course, susceptible of embodiment in many different forms. Shown in the drawings and described hereinbelow in detail is a preferred embodiment of the invention. It is to be understood, however, that the present disclosure is an exemplification of the principles of the invention and does not limit the invention to the illustrated embodiment.

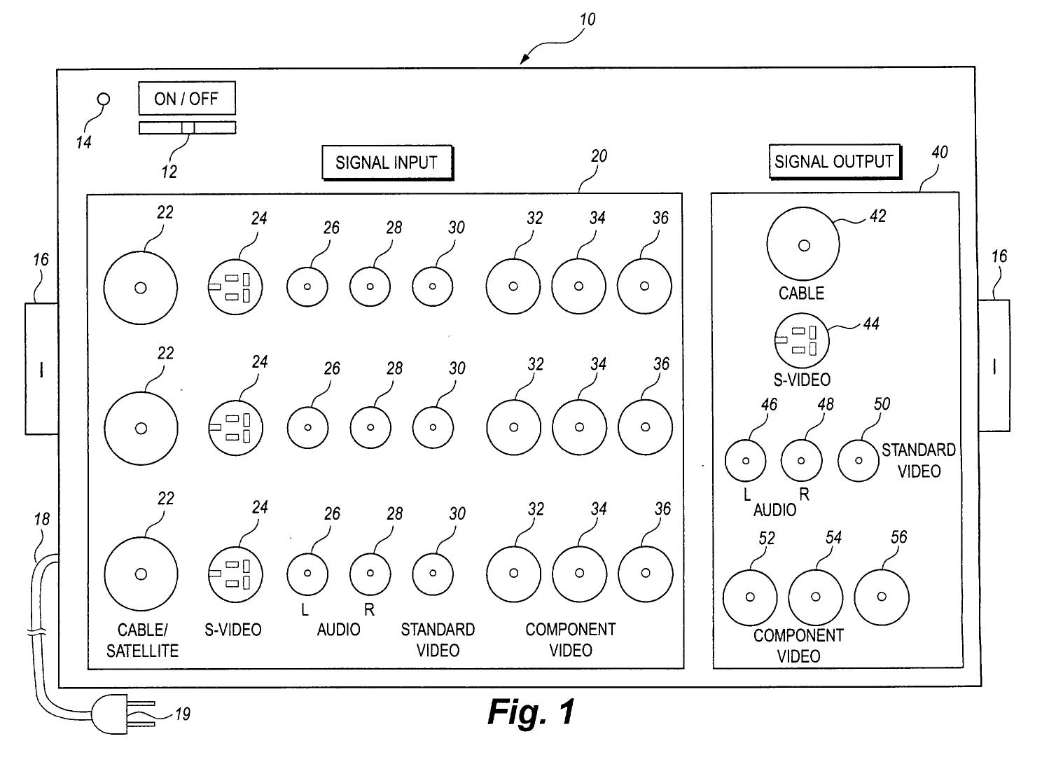

As shown in FIG. 1, the present invention is a device 10 to adapt any incoming TV signal aspect ratio to a full screen TV with an aspect ratio of 4:3. The device 10 includes a housing with signal input terminals 20 and signal output terminals 40. The signal input terminals 20 may include cable/satellite input terminals 22, S-video input terminals 24, audio input terminals 26,28, standard video input terminals 30, and component input terminals 32,34,36. The signal output terminals 40 may include a cable output terminal 42, an S-video output terminal 44, audio output terminals 46,48, a standard video output terminal 50, and component video output terminals 52,54,56. The particular number of input terminals and output terminals may vary according to the desires of the user. The device may also include an electrical cord 18 with a plug 19 to connect the device 10 to an external power source (not shown). The device 10 may also include hand elements 16 for enabling a user to readily carry the device 10.

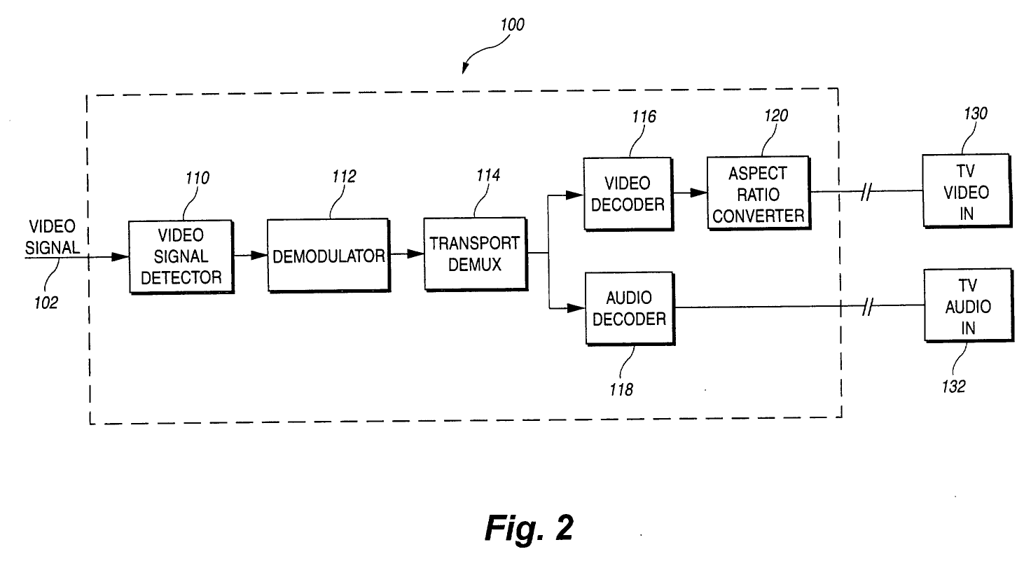

As shown in FIG. 2, contained within the device 10 is electrical circuitry 100 including a video signal detector 110, a demodulator 112, a transport demultiplexer 114, a video decoder 116, an audio decoder 118, and an aspect ratio converter 120. These elements may be configured in the form of integrated electronic circuitry and are electrically interconnected with each other.

An incoming video signal 102 having any TV signal aspect ratio is received through one of the input signal terminals 20. This incoming TV signal 102 may be from a DVD disk, a video cassette, a signal from a cable or satellite, or the like. The incoming TV signal 102 includes a vertical blanking section and a video data section. The vertical blanking section is used by televisions to turn an electron beam off while an electron beam controller resets the position of the electron beam to the upper left corner of the television screen. The vertical blanking section also includes an identification signal which includes the aspect ratio information of the video signal. The video data section includes data which makes up the video picture.

Once the incoming video signal 102 is detected by the video signal detector 110, the video signal detector 110 transfers the video signal to the video demodulator 112. The video demodulator 112 demodulates the video signal and transfers the demodulated video signal to a transport demultiplexer 114. The transport demultiplexer 114 separates the video signal into a video portion signal and an audio portion signal. The video portion signal is then transferred to the video decoder 116 which decodes, analyzes, and determines the aspect ratio of the video signal 102. The decoded video portion signal is then transferred to the aspect ratio converter 120.

The aspect ratio converter 120 converts an aspect parameter or an aspect factor of the decoded video portion signal and outputs a modified video portion signal having an aspect ratio of 4:3 with no black bars on the top and bottom of the modified video portion signal. For example, if the incoming decoded video portion signal has an aspect ratio of 16:9, the aspect ratio converter 120 may modify the decoded video portion signal by zooming into the center of the 16:9 image and cutting out the center of the 16:9 image. The cut out portion of the 16:9 image, e.g., the modified video portion signal, is then transferred to a signal output terminal 40. However, if the incoming decoded video portion has an aspect ratio of 4:3, the aspect ratio converter will do nothing and will transfer the decoded video portion signal as the modified video portion signal to a signal output terminal 40.

The device 10 will enable a user to adapt all incoming TV signals (analogue, digital, HDTV, widescreen, or the like), whether it be from a broadcast, a DVD player, a VHS recording device, a home video camera, or the like, to fit their TV's programmed viewing format so when viewing an analogue, digital, HDTV, widescreen image, or the like, the image will be formatted properly to fit the individual's TV screen by removing the black bars from the top and bottom of the screen.

While the invention has been described with references to its preferred embodiment, it will be understood by those skilled in the art that various changes may be made and equivalents may be substituted for elements thereof without departing from the true spirit and scope of the invention.

We claim:

1. A device to adapt any incoming TV signal aspect ratio to a full screen TV with an aspect ratio of 4:3, said device comprising:
a video signal detector;
a demodulator;
a transport demultiplexer;
a video decoder;
an audio decoder; and
an aspect ratio converter,
wherein said device is configured to adapt any incoming TV signal aspect ratio to a full screen TV with an aspect ratio of 4:3.

2. The device according to claim 1, further comprising an electrical cord with a plug configured to connect said device to an external power source.

3. The device according to claim 1, further comprising housing with signal input terminals and signal output terminals.

4. The device according to claim 2, wherein said signal input terminals comprise at least one cable/satellite input terminal, at least one S-video input terminal, at least one set of left and right audio input terminals, at least one standard video input terminal, and at least one component input terminal.

5. The device according to claim 2, wherein said signal output terminals comprise at least one cable output terminal, at least one S-video output terminal, at least one set of left and right audio output terminals, at least one standard video output terminal, and at least one component video output terminal.

6. The device according to claim 2, wherein said housing comprises hand elements configured to enable a user to carry said device.

7. A method of adapting any incoming TV signal aspect ratio to a full screen TV with an aspect ratio of-4:3, said method comprising:
detecting an incoming video signal;
demodulating the incoming video signal
separating the video signal into a video portion signal and an audio portion signal;
decoding, analyzing, and determining an aspect ratio of the video signal;
if the aspect ratio of the video portion signal is not 4:3 converting the video portion signal into a modified video portion signal having a full screen aspect ratio of 4:3;
if the aspect ration of the video portion signal is 4:3 doing nothing to the video portion signal and transferring the video portion signal as a modified video portion signal.
